(19) United States
(12) Patent Application Publication
(10) Pub. No.: US 2024/0231963 A1
(43) Pub. Date: Jul. 11, 2024

(54) ELECTRONIC DEVICE AND NOTIFICATION MESSAGE DISPLAY METHOD THEREOF

(71) Applicant: SAMSUNG ELECTRONICS CO., LTD., Suwon-si (KR)

(72) Inventors: Joohee PARK, Suwon-si (KR); Nayoung KANG, Suwon-si (KR)

(73) Assignee: SAMSUNG ELECTRONICS CO., LTD., Suwon-si (KR)

(21) Appl. No.: 18/385,702

(22) Filed: Oct. 31, 2023

Related U.S. Application Data
(63) Continuation of application No. PCT/KR2023/016030, filed on Oct. 17, 2023.

(30) Foreign Application Priority Data
Jan. 6, 2023 (KR) 10-2023-0002455

(51) Int. Cl. G06F 9/54

(52) U.S. Cl. CPC G06F 9/542; G06F 9/546

(57) ABSTRACT

A notification message display method of an electronic device, the method including receiving, from a server device, a notification message and keyword metadata corresponding to an event occurrence of an external electronic device; determining contextual information of a user based on a notification acknowledgement action being input from the user; determining at least one keyword that corresponds to the determined contextual information; and, based on the determined at least one keyword and the determined contextual information, maintaining the notification message and displaying the maintained notification message on a screen, or reconstructing the notification message and displaying the reconstructed notification message on the screen.

### CROSS-REFERENCE TO RELATED APPLICATIONS

This application is a continuation application, under 35 U.S.C. § 111(a), of International Application No. PCT/KR2023/016030, filed on Oct. 17, 2023, which claims priority under 35 U.S.C. § 119 to Korean Patent Application 10-2023-0002455, filed on Jan. 6, 2023, in the Korean Intellectual Property Office, the disclosures of which are incorporated by reference herein in their entireties.

### TECHNICAL FIELD

The disclosure relates to an electronic device and a notification message display method thereof, and more particularly, to a method of reconstructing a notification message based on contextual information of a user.

### BACKGROUND ART

Today's electronic devices may have access to a large amount of information and services over the Internet network. In addition, functions of electronic devices including home appliances are rapidly increasing, electronic devices such as smartphones, televisions, computers, and the like, perform various functions, and users may check notification messages regarding the performance of functions.

When a user randomly receives various notification messages from a plurality of electronic devices, the user may experience inconvenience in checking all the notification messages. Accordingly, such notification messages are required to be reconstructed considering the user's situation.

### DISCLOSURE

### Technical Problem

The disclosure is directed to providing an electronic device and a notification message display method thereof that may change a keyword of an already transmitted notification message depending on a user's situation and a state of the electronic device.

Further, the disclosure is directed to providing an electronic device and a notification message display method thereof that may highlight a keyword based on a user's specific interaction.

### Technical Solution

Aspects of embodiments of the disclosure will be set forth in part in the description which follows and, in part, will be apparent from the description, or may be learned by practice of the presented embodiments.

According to an embodiment of the disclosure, a notification message display method of an electronic device is provided, the method including receiving, from a server device, a notification message and keyword metadata corresponding to an event occurrence of an external electronic device; determining contextual information of a user based on a notification acknowledgement action being input from the user: determining at least one keyword that corresponds to the determined contextual information: and, based on the determined at least one keyword and the determined contextual information, maintaining the notification message and displaying the maintained notification message on a screen, or reconstructing the notification message and displaying the reconstructed notification message on the screen.

According to an embodiment of the disclosure, the determining of the at least one keyword may include determining whether the contextual information of the user is changed, and based on determining that the contextual information is changed, determining the at least one keyword that corresponds to the changed contextual information.

According to an embodiment of the disclosure, the determining of whether the contextual information of the user is changed may include determining that the contextual information of the user is changed based on an event at a time that the notification message was received being different from an event at a time that the notification acknowledgement action is input.

According to an embodiment of the disclosure, the determining of whether the contextual information of the user is changed may include determining that the contextual information of the user is changed based on a location of the user at a time that the notification message was received being different from a location of the user at a time that the notification acknowledgement action is input.

According to an embodiment of the disclosure, the determining of the at least one keyword may include reducing a quantity of the at least one keyword based on a size of the screen.

According to an embodiment of the disclosure, the reducing of the quantity of the at least one keyword may include reducing the quantity of the at least one keyword by omitting a low priority keyword.

According to an embodiment of the disclosure, the determining of the at least one keyword may include reducing a quantity of the at least one keyword based on content being displayed on the screen.

According to an embodiment of the disclosure, the determining of the at least one keyword may include reducing a quantity of the at least one keyword due to a size of a text displayed on the screen.

According to an embodiment of the disclosure, the determining of the at least one keyword may include differently determining the at least one keyword of the electronic device, based on the notification acknowledgement action being input to the external electronic device.

According to an embodiment of the disclosure, the reconstructing of the notification message may include, based on a preset user command being input to an inputter, reconstructing the notification message by highlighting the at least one keyword, or omitting the notification message except for the at least one keyword.

According to an embodiment of the disclosure, an electronic device includes a communicator configured to receive, from a servicer device, a notification message and keyword metadata corresponding to an event occurrence of an external electronic device: an inputter configured to receive a user command from a user: a screen: and a controller configured to determine contextual information of the user based on a notification acknowledgement action being input from the user, determine at least one keyword that that corresponds to the determined contextual information, and, based on the determined at least one keyword and the determined contextual information, maintain the notification message and control the screen to display the maintained notification message, or reconstruct the notification message and control the screen to display the reconstructed notification message.

According to an embodiment of the disclosure, the controller may be configured to determine whether the contextual information of the user is changed, and, based on determining that the contextual information is changed, determine the at least one keyword that corresponds to the changed contextual information.

According to an embodiment of the disclosure, the controller may be configured to determine that the contextual information of the user is changed based on an event at a time that the notification message was received being different from an event at a time that the notification acknowledgement action is input.

According to an embodiment of the disclosure, the controller may be configured to determine that the contextual information of the user is changed based on a location of the user at a time that the notification message was received being different from a location of the user at a time that the notification acknowledgement action is input.

According to an embodiment of the disclosure, the controller may be configured to reduce a quantity of the at least one keyword based on a size of the screen.

One aspect of the disclosure provides an electronic device including: a communicator configured to receive a notification message and keyword metadata corresponding to an event occurrence of an external electronic device from a server device; an inputter configured to receive a user command from a user; an outputter configured to display the notification message; and a controller configured to determine at least one keyword that matches contextual information of the user based on a notification acknowledgement action being input from the user, maintain or reconstruct the notification message based on the at least one keyword and the contextual information, and display the maintained or reconstructed notification message on the outputter.

The controller may be configured to determine whether the contextual information of the user is changed, and based on the contextual information being changed, determine the at least one keyword that matches the changed contextual information.

The controller may be configured to determine that the contextual information of the user is changed, based on an event from a time that the notification message was received being different from an event from a time that the notification acknowledgement action is input.

The controller may be configured to determine that the contextual information of the user is changed, based on a location of the user from a time that the notification message was received being different from a location of the user from a time that the notification acknowledgement action is input.

The controller may be configured to reduce a number of the at least one keyword, as a size of the outputter is smaller.

The controller may be configured to reduce the number of the at least one keyword by omitting a low priority keyword, based on priority of the at least one keyword.

The controller may be configured to reduce the number of the at least one keyword, based on content being displayed on the outputter.

The controller may be configured to reduce the number of the at least one keyword, as a size of a text displayed on the outputter is larger.

The controller may be configured to differently determine the at least one keyword of the electronic device, based on the notification acknowledgement action being input to the external electronic device.

The controller may be configured to reconstruct the notification message by highlighting the at least one keyword or omitting a message except for the at least one keyword, based on a preset user command being input to the inputter.

### Advantageous Effects

According to an embodiment of the disclosure, an electronic device and a notification message display method thereof may change a keyword of an already transmitted notification message depending on a user's situation and a state of the electronic device, thereby improving user convenience.

According to an embodiment of the disclosure, an electronic device and a notification message display method thereof may highlight a keyword based on a specific interaction of a user, thereby allowing the user to effectively recognize a notification message.

### DESCRIPTION OF DRAWINGS

These and/or other embodiments of the disclosure will become apparent and more readily appreciated from the following description of embodiments, taken in conjunction with the accompanying drawings of which:

FIG. 1 is a schematic diagram illustrating communication among a server device and electronic devices according to an embodiment of the disclosure.

FIG. 2 is a control block diagram illustrating an electronic device according to an embodiment of the disclosure.

FIG. 3 is a control block diagram illustrating a server device according to an embodiment of the disclosure.

FIG. 4 is a flowchart illustrating operations of an electronic device and a server device according to an embodiment of the disclosure.

FIG. 5 is a diagram illustrating data for determining contextual information of a user in an electronic device according to an embodiment of the disclosure.

FIG. 6 is a diagram illustrating that a notification message corresponding to an event occurrence is received in an electronic device according to an embodiment of the disclosure.

FIG. 7 is a diagram illustrating that a notification message is reconstructed and displayed at a time that the notification message is confirmed in an electronic device according to an embodiment of the disclosure.

FIG. 8 is a diagram illustrating that a notification message corresponding to an event occurrence is received in an electronic device according to an embodiment of the disclosure.

FIG. 9 is a diagram illustrating that a notification message is reconstructed and displayed at a time that the notification message is confirmed in an electronic device according to an embodiment of the disclosure.

FIG. 10 is a diagram illustrating that a notification message corresponding to an event occurrence is received in a plurality of electronic devices according to an embodiment of the disclosure.

FIG. 11 is a diagram illustrating that a notification message is confirmed in any one of the plurality of electronic devices according to an embodiment of the disclosure.

FIG. 12 is a diagram illustrating that a notification message is reconstructed and displayed in another of the plurality of electronic devices according to an embodiment of the disclosure.

FIG. 13 is a diagram illustrating that a notification message corresponding to an event occurrence is received in a plurality of electronic devices according to an embodiment of the disclosure.

FIG. 14 is a diagram illustrating notification messages reconstructed and displayed differently in the plurality of electronic devices according to an embodiment of the disclosure.

FIG. 15 is a diagram illustrating notification messages reconstructed and displayed differently in a plurality of electronic devices according to an embodiment of the disclosure.

FIG. 16 is a diagram illustrating that notification messages are differently reconstructed and displayed based on whether content is being displayed in an electronic device according to an embodiment of the disclosure.

FIG. 17 is a diagram illustrating preset interactions which are input by a user to an electronic device according to an embodiment of the disclosure.

FIG. 18 is a diagram illustrating keywords highlighted based on user interaction in an electronic device according to an embodiment of the disclosure.

FIG. 19 is a diagram illustrating that only keywords are displayed by omitting messages other than the keywords based on user interaction in an electronic device according to an embodiment of the disclosure.

FIG. 20 is a diagram illustrating that notification messages corresponding to event occurrence are received in an electronic device according to an embodiment of the disclosure.

FIG. 21 is a diagram illustrating that notification messages are reconstructed based on keywords in an electronic device according to an embodiment of the disclosure.

FIG. 22 is a diagram illustrating a difference in information depending on whether a notification message is reconstructed, in response to increasing a text size in an electronic device according to an embodiment of the disclosure.

FIG. 23 is a flowchart illustrating operations of an electronic device according to an embodiment of the disclosure.

FIG. 24 is a flowchart specifically illustrating operations of updating a keyword in an electronic device according to an embodiment of the disclosure.

### MODES OF THE DISCLOSURE

Various embodiments of the present disclosure and terms used therein are not intended to limit the technical features described in the present disclosure to particular embodiments, and it should be construed as including various modifications, equivalents, or alternatives of a corresponding embodiment.

With regard to description of drawings, similar reference numerals may be used for similar or related components.

A singular form of a noun corresponding to an item may include one item or a plurality of the items unless context clearly indicates otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

It will be understood that the terms “first”, “second”, etc., may be used only to distinguish one component from another, not intended to limit the corresponding component in other aspects (e.g., importance or order).

It is said that one (e.g., first) component is “coupled” or “connected” to another (e.g., second) component, with or without the terms “functionally” or “communicatively”. When referenced, it means that one component can be connected to the other component directly (e.g., by wire), wirelessly, or through a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will also be understood that when one component is referred to as being “on” or “over” another component, it can be directly on the other component or intervening components may also be present.

The term “and/or” includes any and all combinations of one or more of a plurality of associated listed items.

Hereinafter, embodiments of the disclosure will be described in detail with reference to the accompanying drawings.

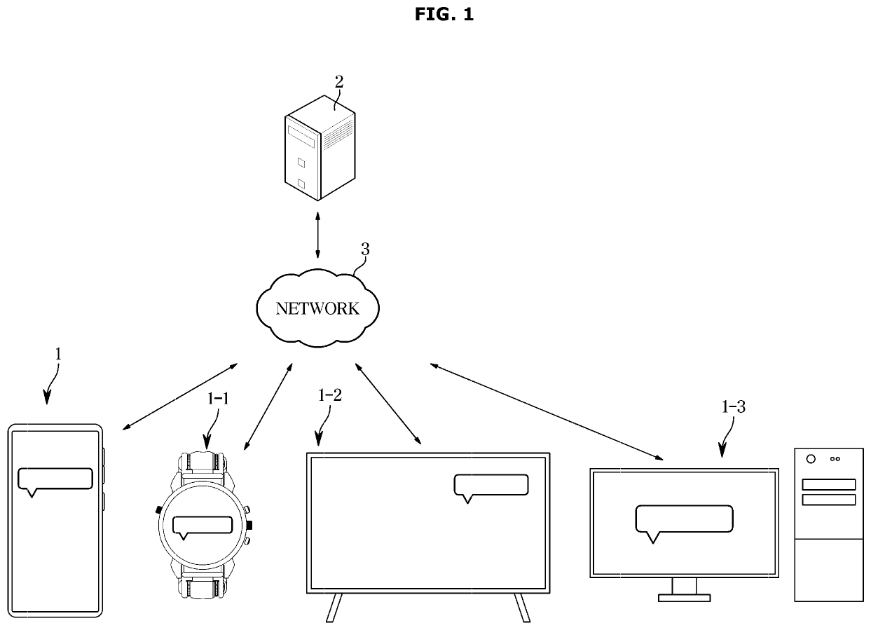

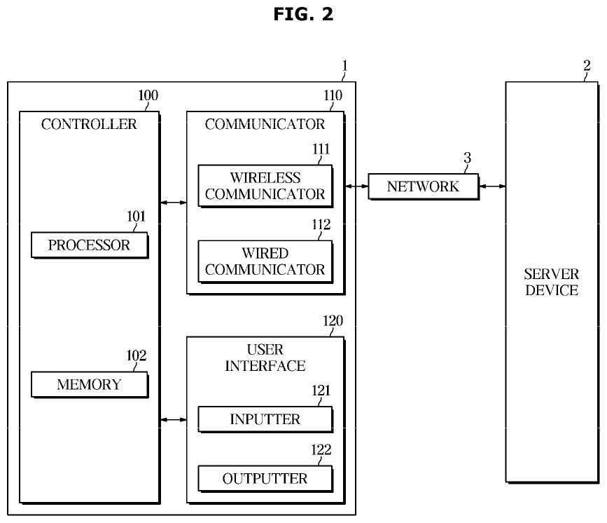

FIG. 1 is a schematic diagram illustrating communication among a server device and electronic devices according to an embodiment, and FIG. 2 is a control block diagram illustrating an electronic device according to an embodiment.

An electronic device 1 may include a user device, a communicator 110 capable of communicating with other electronic devices 1 or a server device 2, a user interface 120 receiving a user input or outputting information to a user, at least one processor 101 controlling an operation of the electronic device 1, and at least one memory 102 storing a program for controlling the operation of the electronic device 1.

The electronic device 1 may be at least one of various types of home appliances. For example, the electronic device 1 may include a smartphone, a smartwatch as a user device, and may include at least one of a refrigerator, a television, a personal computer, a dishwasher, an electric range, an electric oven, an air conditioner, a clothing care apparatus, a washing machine, a dryer, and a microwave oven, without being limited thereto. For example, the electronic device 1 may include various types of appliances not shown in the drawings, such as a cleaning robot, a vacuum cleaner, an induction heating appliance, and the like. Furthermore, the aforementioned home appliances are only examples, and in addition to the aforementioned home appliances, other appliances connected to the electronic device 1 or the server device 2 to perform operations described below may be included in the electronic device 1 according to an embodiment.

The server device 2 may include a communicator 110 communicating with another server device 2 or electronic devices 1, at least one processor 101 processing data received from the other server or electronic device 1, and at least one memory 102 storing programs for processing data or processed data. The server device 2 may be implemented as a variety of computing devices, such as a workstation, a cloud, a data drive, a data station, and the like. The server device 2 may be implemented as one or more server physically or logically separated based on a function, detailed configuration of function, or data, and may transmit and receive data through communication between servers and process the transmitted and received data.

The server device 2 may perform functions such as managing a user account, registering the electronic device 1 in association with the user account, managing or controlling the registered electronic device 1, and the like. For example, a user may access the server device 2 via the electronic device 1 and may generate a user account. The user account may be identified by an identifier (ID) and a password set by the user. The server device 2 may register the electronic device 1 to the user account according to a predetermined procedure. For example, the server device 2 may link identification information of the electronic device 1 (such as a serial number or MAC address) to the user account to register, manage, and control the electronic device 1. A user device included in the electronic device 1 may include a communication module capable of communicating with the server device 2, a user interface 120 receiving a user input or outputting information to a user, at least one processor 101 controlling an operation of the user device, and at least one memory 102 storing a program for controlling the operation of the user device.

The user device included in the electronic device 1 may be carried by a user, or placed in a user's home or office, or the like. The user device may include a personal computer, a terminal, a portable telephone, a smartphone, a handheld device, a wearable device, and the like, without being limited thereto.

The memory 102 of the user device included in the electronic device 1 may store a program for controlling another electronic device 1, i.e., an application. The application may be sold installed on the user device, or may be downloaded from an external server for installation.

By executing the application installed on the user device by a user, the user may access the server device 2, generate a user account, and perform communication with the server device 2 based on the login user account to register the electronic device 1.

For example, by operating the electronic device 1 to enable the other electronic device 1 to access the server device 2 according to a procedure guided by the application installed on the user device, the server device 2 may register the electronic device 1 with the user account by assigning the identification information (such as a serial number or MAC address) of the other electronic device 1 to the corresponding user account.

A user may control the electronic device 1 using the application installed on the user device. For example, by logging into a user account with the application installed on the user device, the electronic device 1 registered in the user account appears, and by inputting a control command for the electronic device 1, the control command may be delivered to the electronic device 1 via the server device 2.

A network 3 may include both a wired network 3 and a wireless network 3. The wired network 3 may include a cable network 3 or a telephone network 3, and the wireless network 3 may include any networks transmitting and receiving a signal via radio waves. The wired network 3 and the wireless network 3 may be connected to each other.

The network 3 may include a Wide Area Network (WAN) such as the Internet, a Local Area Network (LAN) formed around an Access Point (AP), and a short range wireless network 3 not using an AP. The short range wireless network 3 may include Bluetooth (IEEE 802.15.1), Zigbee (IEEE 802.15.4), Wi-Fi Direct, Near Field Communication (NFC), and Z-Wave, without being limited thereto.

The AP may connect the electronic device 1 or the user device to a WAN. The electronic device 1 or the user device may be connected to the server device 2 via a WAN.

The AP may communicate with the electronic device 1 or the user device using wireless communication such as Wi-Fi (IEEE 802.11), Bluetooth (IEEE 802.15.1), Zigbee (IEEE 802.15.4), etc., and access a WAN using wired communication, without being limited thereto.

According to various embodiments, the electronic device 1 may be directly connected to the user device or server device 2 without going through an AP.

The electronic device 1 may be connected to the user device or the server device 2 via a long range wireless network 3 or a short range wireless network 3.

For example, the electronic device 1 may be connected to the user device via a short range wireless network 3 (e.g., Wi-Fi Direct).

In another example, the electronic device 1 may be connected to the user device or server device 2 via a WAN using a long range wireless network 3 (e.g., a cellular communication module).

In still another example, the electronic device 1 may access a WAN using wired communication, and may be connected to the other electronic device 1 or server device 2 via a WAN.

Upon accessing a WAN using wired communication, the electronic device 1 may also act as an access point. Accordingly, the electronic device 1 may connect the other electronic device 1 to a WAN to which the server device 2 is connected. Further, the other electronic device 1 may connect the electronic device 1 to the WAN to which the server device 2 is connected.

The electronic device 1 may transmit information about an operation or state to the other electronic device 1, the user device, or the server device 2 via the network 3. For example, the electronic device 1 may transmit information about an operation or state to the other electronic device 1, the user device or the server device 2 upon receiving a request from the server device 2, in response to an event in the electronic device 1, or periodically or in real time. In response to receiving the information about the operation or state from the electronic device 1, the server device 2 may update the stored information about the operation or state of the electronic device 1 and transmit the updated information about the operation and state of the electronic device 1 to the user device via the network 3. Here, updating the information may include various operations in which existing information is changed, such as adding new information to the existing information, replacing the existing information with new information, and the like.

The electronic device 1 may obtain various information from the other electronic device 1, the user device, or the server device 2, and may provide the obtained information to a user. For example, the electronic device 1 may obtain information related to a function of the electronic device 1 (e.g., recipes, washing instructions, etc.) from the server device 2 and various environment information (e.g., weather, temperature, humidity, etc.), and may output the obtained information via a user interface.

The electronic device 1 may operate according to a control command received from the other electronic device 1, the user device, or the server device 2. For example, the electronic device 1 may operate in accordance with a control command received from the server device 2, based on a prior authorization obtained from a user to operate in accordance with the control command of the server device 2 even without a user input. Here, the control command received from the server device 2 may include a control command input by the user via the user device or a control command based on preset conditions, without being limited thereto.

The user device may transmit information about a user to the electronic device 1 or the server device 2 through the communicator 110. For example, the user device may transmit information about a user's location, a user's health status, a user's preference, a user's schedule, etc., to the server device 2. The user device may transmit information about the user to the server device 2 based on the user's prior authorization.

The electronic device 1 or the server device 2 may use techniques such as artificial intelligence to determine a control command. For example, the server device 2 may receive information about an operation or a state of the electronic device 1 or information about a user of the user device, process the received information using techniques such as artificial intelligence, and transmit a processing result or a control command to the at least one electronic device 1 including the user device based on the processing result.

Conventionally, important content may not be easily recognized due to an excessive number of notification messages generated by the electronic device 1. Confirming the notification message at a different time from the time the notification message is received increases user confusion. In addition, users who prefer to see large fonts, such as the elderly or people with low eyesight, are able to only see the first few part of the notification message and easily miss the key points, and visually impaired people who mainly use accessibility functions such as “read aloud” require to listen to the notification message all the way through to understand the content.

On the other hand, the notification message display method of the electronic device according to an embodiment of the disclosure may reconstruct and output a notification message based on user's contextual information, and information of the electronic device 1 to effectively convey required information.

That is, according to the notification message display method of the electronic device according to an embodiment, time and digital fatigue may be reduced by quickly delivering a key point to a user who is required to read many notification messages due to diversification of electronic devices 1 and applications, and a notification message display system that enables users, including the disabled and the elderly, to read and listen to notification messages conveniently may be established.

Hereinafter, the disclosure is described in detail with reference to accompanying drawings.

As shown in FIG. 2, the electronic device 1 according to an embodiment may include the communicator 110 communicating with the server device 2 via the network 3, the user interface 120, and a controller 100.

The communicator 110 may be connected to the server device 2, and transmit and receive data to and from the server device 2. Specifically, the communicator 110 may receive a notification message and keyword metadata corresponding to an occurrence of an event, or may transmit a control command of another electronic device 1 to the server device 2.

The communicator 110 may include a wireless communicator 111 that wirelessly transmits and receives data to and from external devices, and a wired communicator 112 that transmits and receives data to and from external devices by wire.

The wireless communicator 111 may communicate wirelessly with a base station or an AP, and may access a wired communication network through the base station or access point. The wireless communicator 111 may also communicate with external devices connected to the wired communication network via a base station or access point. For example, the wireless communicator 111 may communicate wirelessly with an AP using Wi-Fi (e.g., IEEE 802.11 standard), or communicate with a base station using Global System for Mobile Communications (GSM), Code Division Multiple Access (CDMA), Wideband CDMA (WCDMA), Long Term Evolution (LTE), or Wi-Fi. The wireless communicator 111 may also receive data from external devices via a base station or access point.

Furthermore, the wireless communicator 111 may directly communicate with the external devices.

The wired communicator 112 may access a wired communication network and communicate with external devices via the wired communication network. For example, the wired communicator 112 may access the wired communication network via Ethernet (IEEE 802.3 standard) and receive data from external devices via the wired communication network.

A communication method between the server device 2 and the communicator 110 is not limited.

The user interface 120 is provided on an outer surface of the electronic device 1, and may receive a control command from a user and display information related to an operation of the electronic device 1.

The user interface 120 may include an inputter 121 receiving a control command and an outputter 122 displaying information related to an operation.

The inputter 121 may be implemented as at least one of an input means such as a touch screen, a push button, a membrane button, a dial, a slider switch, and the like, without being limited thereto.

The outputter 122 may be implemented as a display means such as a Plasma Display Panel (PDP), a Liquid Crystal Display (LCD) panel, a Light Emitting Diode (LED) panel, an Organic Light Emitting Diode (OLED) panel, an Active-matrix Organic Light-Emitting Diode (AMOLED) panel, a Curved Display Panel, and the like, which may be generally referred to as screens, without being limited thereto.

Also, the outputter 122 may be implemented as a Touch Screen Panel (TSP) that further includes a touch input means to detect user contact. In a case where the outputter 122 is implemented as a Touch Screen Panel, a user may input a control command by touching the outputter 122.

The controller 100 outputs a control signal to provide overall control of the electronic device 1. The controller 100 may correspond to one or more processors 101. In this instance, the processor 101 may be implemented as an array of logic gates, or may be implemented as a combination of the general-purpose microprocessor 101 and a memory 102 storing a program executable in the microprocessor 101.

The memory 102 may store various information required for an operation of the electronic device 1. Specifically, the memory 102 may store an operating system or a program required for an operation of the electronic device 1, or store data required for an operation of the electronic device 1.

For example, the memory 102 may store keyword metadata corresponding to contextual information of a user. The keyword metadata refers to words that constitute a notification message, and the controller 100 may reconstruct the notification message by selecting different keyword metadata based on a change in the user's contextual information.

In addition, the memory 102 may include a high-speed random access memory, a magnetic disc, Static Random Access Memory (SRAM), Dynamic Random Access Memory (DRAM), Read Only Memory (ROM), and the like, without being limited thereto.

Furthermore, the memory 102 may be detachable from the device. For example, the memory 102 may include a Compact Flash Card (CF Card), a Secure Digital Card (SD Card), a Smart Media Card (SM Card), a Multimedia Card (MMC), or a Memory Stick, without being limited thereto.

The controller 100 may control each component to reconstruct the notification message that is to be displayed on the outputter 122.

Specifically, the controller 100 may receive, from the server device 2, a notification message and keyword metadata corresponding to an occurrence of an event of the external electronic device 1, determine at least one keyword that matches the user's contextual information based on an input of a notification acknowledgement action from the user, maintain or reconstruct the notification message based on the at least one keyword and the contextual information, and display the maintained or reconstructed notification message on the outputter 122.

The controller 100 may also determine whether the user's contextual information has changed, and based on the change in contextual information, determine the at least one keyword that matches the changed contextual information.

In addition, the controller 100 may determine that the user's contextual information has changed, based on an event from a time that the notification message was received being different from an event from a time that the notification acknowledgement action is input, and may determine that the user's contextual information has changed, based on a location of the user from a time that the notification message was received being different from a location of the user from a time that the notification acknowledgement action is input.

Furthermore, the controller 100 may reduce the number of the at least one keyword, as a size of the outputter 122 is smaller, may reduce the number of the at least one keyword based on content being displayed on the outputter 122, or may reduce the number of the at least one keyword, as a size of a text displayed on the outputter 122 is larger.

In this instance, the controller 100 may reduce the number of the at least one keyword by omitting a low priority keyword, based on priority of the at least one keyword.

In addition, the controller 100 may differently determine the at least one keyword of the electronic device, based on the notification acknowledgement action being input to the external electronic device 1.

Furthermore, the controller 100 may reconstruct the notification message by highlighting the at least one keyword or omitting a message except for the at least one keyword, based on a preset user command being input to the inputter 121.

Accordingly, the controller 100 of the electronic device 1 according to an embodiment may reconstruct the notification message considering the user's contextual information.

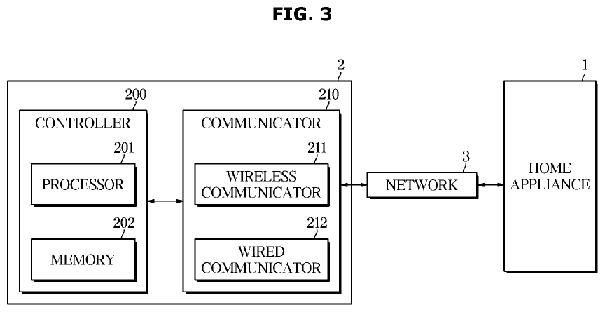

FIG. 3 is a control block diagram illustrating a server device according to an embodiment.

As shown in FIG. 3, the server device 2 according to an embodiment may include a communicator 210 communicating with the electronic device 1 via the network 3 and a controller 200.

The communicator 210 may be connected to the electronic device 1 and transmit and receive data to and from the electronic device 1. Specifically, the communicator 210 may transmit a notification message and keyword metadata corresponding to an occurrence of an event to the electronic device 1, or may receive a control command of another electronic device 1 from the electronic device 1. The communicator 210 may include a wireless communicator 211 that wirelessly transmits and receives data to and from external devices, and a wired communicator 212 that transmits and receives data to and from external devices by wire.

Detailed configurations and operations of the wireless communicator 211 and the wired communicator 212 are duplicated with those of the wireless communicator 111 and the wired communicator 112 of the electronic device 1, and thus descriptions thereof are omitted herein.

The controller 200 outputs a control signal to provide overall control of the server device 2. The controller 200 may correspond to one or more processors 201. In this instance, the processor 201 may be implemented as an array of logic gates, or may be implemented as a combination of a general-purpose microprocessor 201 and a memory 202 storing a program executable in the microprocessor 201.

The memory 202 may store various information required for an operation of the server device 2. Specifically, the memory 202 may store an operating system or a program required for an operation of the server device 2, or store data required for an operation of the server device 2.

The controller 200 of the server device 2 may receive an event occurrence signal from an external electronic device 1, and may generate a notification message from the keyword metadata corresponding to the event occurrence accordingly. The controller 200 may then transmit the generated notification message and keyword metadata to the electronic device 1 via the network 3.

That is, the server device 2 may serve to generate and transmit the notification message and keyword metadata to the electronic device 1 such that the electronic device 1 may reconstruct the notification message.

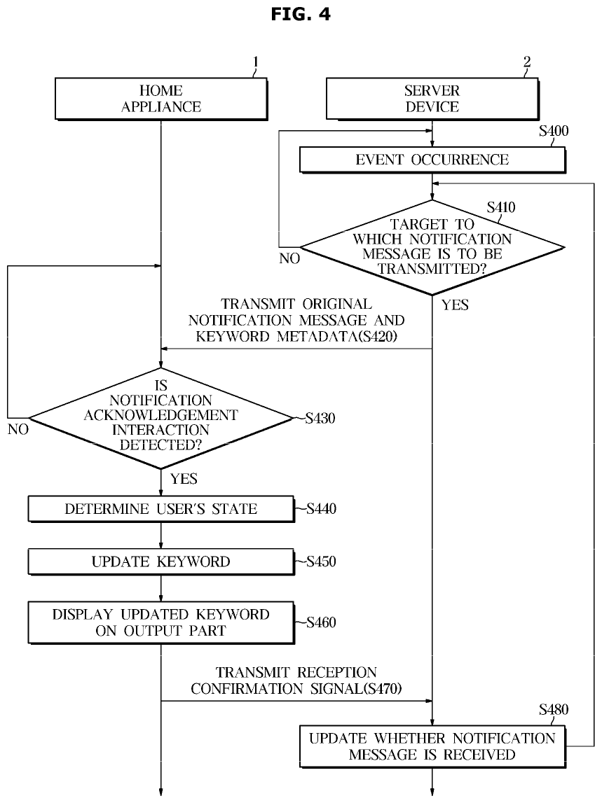

FIG. 4 is a flowchart illustrating operations of an electronic device and a server device according to an embodiment.

Referring to FIG. 4, the server device 2 may receive an event occurrence signal from the electronic device 1 (S400). In response to receiving the event occurrence signal from the electronic device 1, the server device 2 may determine whether the electronic device 1 to which an original notification message and keyword metadata are to be transmitted is a target to which the notification message will be transmitted (S410). That is, the server device 2 may exclude the electronic device 1 that has already received and confirmed the notification message from the target to which the notification message will be transmitted.

Thereafter, based on a determination that the electronic device 1 has received and not confirmed the notification message (Yes in operation S410), the server device 2 may transmit the original notification message and the keyword metadata to the electronic device 1 (S420). In this instance, the notification message may refer to a message about an operation of the electronic device 1, for example, “Wash will be completed in 10 minutes”, and the keyword metadata may refer to data about keywords constituting the notification message, for example, “wash”, “10 minutes”, and “completed”.

The electronic device 1 may receive the original notification message and the keyword metadata, and determine whether a notification acknowledgement interaction from a user is detected (S430). In this instance, the notification acknowledgement interaction refers to a user's action to acknowledge (confirm) the notification message, and may include, for example, a tapping motion by the user to check the notification message on a smartphone, or an operation of a remote control to check the notification message on a smart TV.

The electronic device 1 may determine a user's situation (S440), based on the user's notification acknowledgement interaction being detected, and generate contextual information of the user. Here, the user's contextual information refers to information about the user's situation at a time that the user performs a notification acknowledgement action, and may include a time difference between a time that the notification message is received and a time that the user acknowledges the notification message, location information of the user, information about whether the notification message was confirmed in another electronic device 1, information about whether content is being displayed on the outputter 122, information about a display size of the electronic device 1 from which the notification acknowledgement action was received, and the like.

The electronic device 1 may then determine at least one keyword that matches the user's contextual information, update the at least one keyword (S450), and maintain or reconstruct the notification message based on the at least one keyword and the contextual information.

The electronic device 1 may display the keyword updated by being maintained or reconstructed on the outputter 122 (S460), and transmit a reception confirmation signal to the server device 2 (S470).

That is, as described above, because the notification message has been confirmed, the electronic device 1 may transmit the reception confirmation signal to the server device 2 to prevent the notification message from being transmitted again, and the server device 2 may update whether the electronic device 1 has received the notification message (S480).

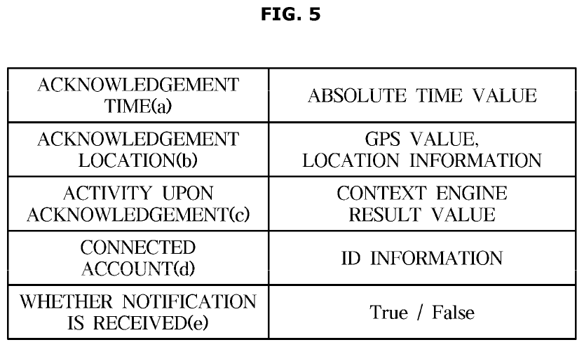

FIG. 5 is a diagram illustrating data for determining contextual information of a user in an electronic device according to an embodiment.

In operation S440 of FIG. 4, the controller 100 of the electronic device 1 may determine the contextual information of the user, and data shown in FIG. 5 may be considered in determining the contextual information.

Referring to FIG. 5, the controller 100 of the electronic device 1 may determine the user's contextual information by considering the data from (a) to (e). Specifically, the data may include a time that the user acknowledges the notification message (a), a location where the user acknowledges the notification message (b), activity information at the time that the user acknowledges the notification message (c), a connected account (d), and information about whether the corresponding notification message has been received (e).

The controller 100 may consider the time that the user acknowledges the notification message (a) to determine the user's contextual information, and may determine whether the user's contextual information has changed based on an absolute time value from the time that the notification message is received in the electronic device 1 to the time that the user acknowledges the notification message (a).

For example, based on the absolute time value from the time that the notification message is received in the electronic device 1 to the time that the user acknowledges the notification message (a) being one hour, which is a preset reference time, it may be determined that the user's contextual information has changed. Accordingly, the notification message may be reconstructed.

The controller 100 may consider the location where the user acknowledges the notification message (b) to determine the user's contextual information, and may determine whether the user's contextual information has changed, based on a GPS value or location information that is a user's location at a time that a notification message acknowledgement action is input.

For example, based on the user being located further than a preset reference distance of 3 km from a user's house at the time that the notification message acknowledgement action is input from the user, it may be determined that the user's contextual information has changed. Accordingly, the notification message may be reconstructed.

The controller 100 may consider the activity information at the time that the user acknowledges the notification message (c) to determine the user's contextual information, and may obtain the user's activity information from a result value of a context engine that derives the user's activity information.

For example, in response to a notification message of “Drying is completed” being generated after completing an operation of a dryer and it is determined that the user is exercising at the time that a notification message acknowledgement action is input from the user, the notification message may be reconstructed as “Wrinkle prevention function is activated, until the user finishes an exercise”.

The controller 100 may consider the user's connected account (d) of the electronic device 1 to determine the user's contextual information, and may determine whether the user is logged into a plurality of electronic devices 1 with the same ID information.

For example, in response to the notification message being acknowledged through a smartwatch by the user who has been logged in the smartwatch and a smartphone with the same ID, the notification message may be reconstructed at a time that the user acknowledges the notification message on the smartphone. That is, because the user has already acknowledged the notification message on the smartwatch, the notification message on the smartphone may be reconstructed to include content of urging an action requested by the notification message.

The controller 100 may consider information about whether the same notification message has been received (e) in another electronic device 1 to determine the user's contextual information, and may reconstruct the notification message based on the notification message having been confirmed in the other electronic device 1.

In this instance, reconstructing the notification message by the controller 100 of the electronic device 1 based on the user's contextual information and keyword metadata may be performed by a program stored in the memory 102, or by a model trained by machine learning.

Specifically, the program stored in the memory 102 may reconstruct the notification message based on a rule-base. That is, all the cases of the user's contextual information may be stored in the memory 102, and keyword metadata corresponding thereto may be matched and stored in the memory 102. Accordingly, the controller 100 may reconstruct the notification message based on a matching relationship between the user's contextual information and the keyword metadata stored in the memory 102.

The controller 100 may train an artificial neural network using the user's contextual information and the keyword metadata as training data.

In a case where the controller 100 includes the processor 101 (e.g., a Neural Processing Unit (NPU)) dedicated to artificial intelligence (AI) for training an artificial neural network, the processor 101 may train the artificial neural network using the data stored in the memory 102 as training data of the artificial neural network.

Examples of learning algorithms include supervised learning, unsupervised learning, semi-supervised learning, or reinforcement learning, without being limited thereto.

The artificial neural network may include a plurality of neural network layers. Each of the plurality of neural network layers has a plurality of weight values, and performs a neural network operation by performing computation between an operation result of a previous layer and the plurality of weight values. The plurality of weight values of the plurality of neural network layers may be optimized by the training results of AI model. For example, the plurality of weight values may be updated such that a loss value or cost value obtained by the AI model during the training process is reduced or minimized.

The artificial neural network may include a Deep Neural Network (DNN), for example, a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), or a Deep Q-Networks, and the like, without being limited thereto.

The controller 100 may learn a relationship among the user's contextual information, keyword metadata and updated keyword based on the selected AI model, and update keywords that are to be used to reconstruct the notification message based on the trained model.

Accordingly, the electronic device 1 according to an embodiment may update keywords through machine learning, and thus an accuracy of updating keywords may be improved even though conditions of the electronic device 1 or environment are changed.

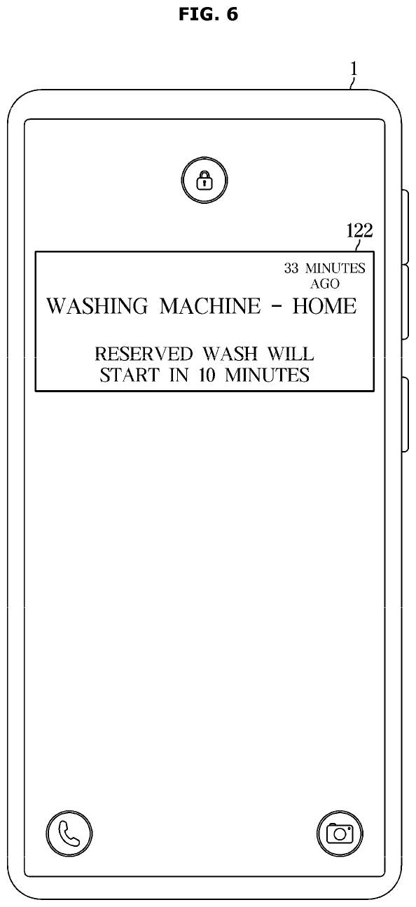

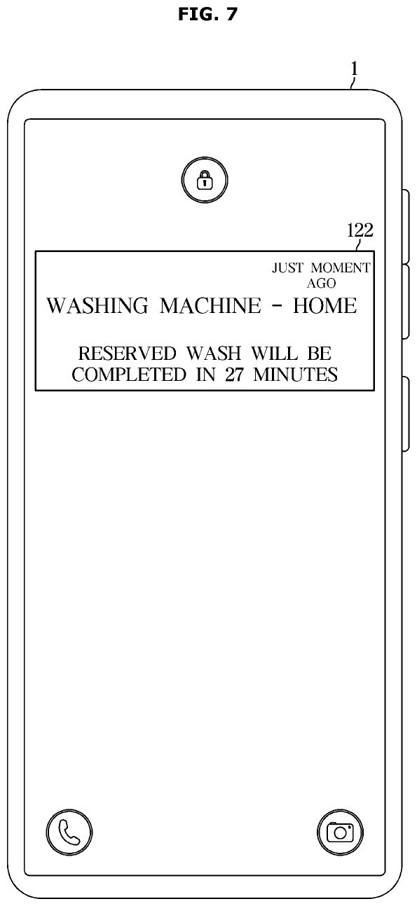

FIG. 6 is a diagram illustrating that a notification message corresponding to an event occurrence is received in an electronic device according to an embodiment. FIG. 7 is a diagram illustrating that a notification message is reconstructed and displayed at a time that the notification message is confirmed in an electronic device according to an embodiment.

Referring to FIG. 6, a washing machine, which is an external electronic device, may transmit an event occurrence signal to the server device 2 in response to an occurrence of an event of a reserved wash notification. In response to the above, the server device 2 may transmit a notification message and keyword metadata corresponding to the event occurrence to a smartphone which is the electronic device 1.

The controller 100 of the electronic device 1 may then receive the notification message and the keyword metadata from the server device 2, and may display the notification message of “The reserved wash will start in 10 minutes” on the outputter 122, together with “washing machine” which is the external electronic device where the event occurs, “home” which is a place where the event occurs, and “33 minutes ago” which is an elapsed time since the notification message was received.

In this instance, the elapsed time since the notification message was received may be updated over time.

Referring to FIG. 7 together with FIG. 6, the controller 100 of the electronic device 1 of FIG. 7 may determine whether a notification acknowledgement action is input from a user. For example, the user may double-tap the inputter 121, which is a screen of the smartphone, to acknowledge the received notification message, and the controller 100 may determine the double-tap of the user as the notification acknowledgement action.

Based on a determination that the user has input the notification acknowledgement action, the controller 100 may determine whether contextual information of the user has changed at a time that the notification acknowledgement action is input. Specifically, the controller 100 may determine that the user's contextual information has changed, based on an event from a time that the notification message was received being different from an event from a time that the notification acknowledgement action is input. Referring to FIG. 7 as an example, the electronic device has received the notification message corresponding to the event related to the reserved wash, i.e., the reserved wash will start in 10 minutes, in FIG. 6, and then at the time that the notification acknowledgement action is input, the event has changed to an event related to an end of wash, as shown in FIG. 7. Accordingly, the controller 100 may determine that the user's contextual information has changed.

Thus, the controller 100 may select keywords corresponding to the changed contextual information, “in 27 minutes” and “completed”, in the memory 102. Thereafter, the controller 100 may update the keywords, and reconstruct the notification message from “Reserved wash will start in 10 minutes” to “Reserved wash will be completed in 27 minutes”.

In a case where the notification message is reconstructed, the controller 100 may only display the reconstructed notification message without displaying the previous notification message to replace the previous notification message with the reconstructed notification message.

Furthermore, in addition to the method of directly replacing the keywords as in FIG. 7, keywords may be reconstructed by omitting or adding keywords. For example, in a case where a reconstructed notification message is “Black Friday sales just began”, the reconstructed notification message may be reconstructed to “Black Friday sales began 15 minutes ago” by omitting “just” and adding “15 minutes ago”.

Conventionally, a user is required to confirm every single notification message accumulated over time, which is inconvenient. However, by the notification message display method of the electronic device according to an embodiment, only information corresponding to the time that the notification message is acknowledged may be confirmed, enabling the user to recognize the notification message accurately and quickly.

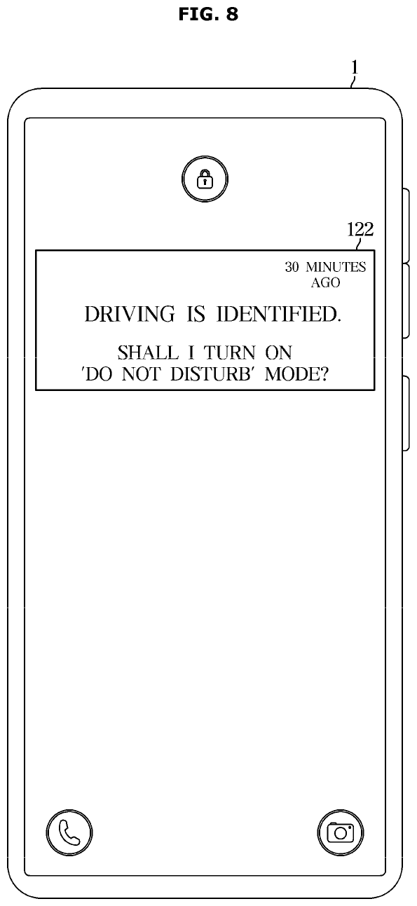

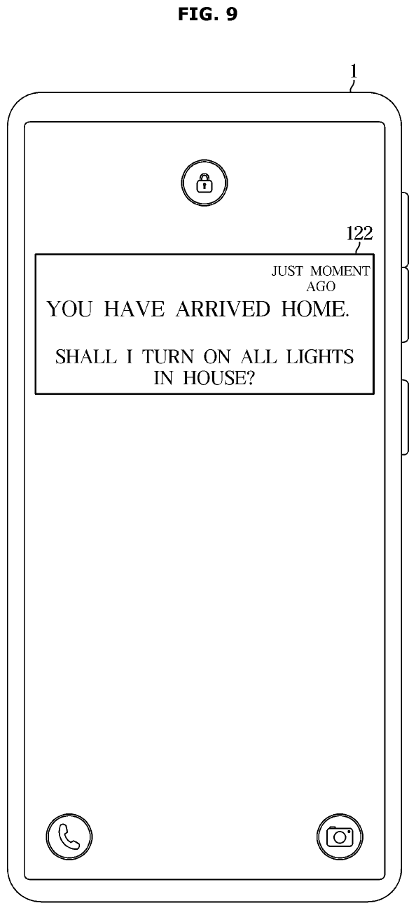

FIG. 8 is a diagram illustrating that a notification message corresponding to an event occurrence is received in an electronic device according to an embodiment. FIG. 9 is a diagram illustrating that a notification message is reconstructed and displayed at a time that the notification message is confirmed in an electronic device according to an embodiment.

Referring to FIG. 8, a smartphone included in the electronic device 1 may transmit an event occurrence signal to the server device 2, in response to an occurrence of an event that meets a condition of ‘Do not disturb’ mode recommendation. In response to the above, the server device 2 may transmit a notification message and keyword metadata corresponding to the occurrence of the event to the smartphone.

The controller 100 of the electronic device 1 may then receive the notification message and the keyword metadata from the server device 2, and display, on the outputter 122, the notification message of “Driving is identified. Shall I turn on ‘do not disturb’ mode?” together with “30 minutes ago” which is an elapsed time since the notification message was received.

In this instance, the elapsed time since the notification message was received may be updated over time.

Referring to FIG. 9 and FIG. 8 together, the controller 100 of the electronic device 1 of FIG. 9 may determine whether a notification acknowledgement action is input from a user. For example, the user may press a lock button on a smartphone to check a notification message received in the smartphone, and the controller 100 may determine receiving an input signal from the lock button as the notification acknowledgement action.

Based on a determination that the user has input the notification acknowledgement action, the controller 100 may determine whether contextual information of the user has changed at a time that the notification acknowledgement action is input. Specifically, the controller 100 may determine that the user's contextual information has changed, based on a location of the user from a time that the notification message was received being different from a location of the user from the time that the notification acknowledgement action is input. Referring to FIG. 9 as an example, the electronic device has received the notification message corresponding to the event related to the ‘Do not disturb’ mode in FIG. 8, and then at the time that the notification acknowledgement action is input, the user's location has changed to near home in FIG. 9. Accordingly, the controller 100 may determine that the user's contextual information has changed.

Thus, the controller 100 may select keywords corresponding to the changed contextual information, “house”, “lights”, and “all” in the memory 102. Thereafter, the controller 100 may update the keywords to reconstruct the notification message from “Shall I turn on ‘Do not disturb’ mode?” to “Shall I turn on all the lights in the house?”.

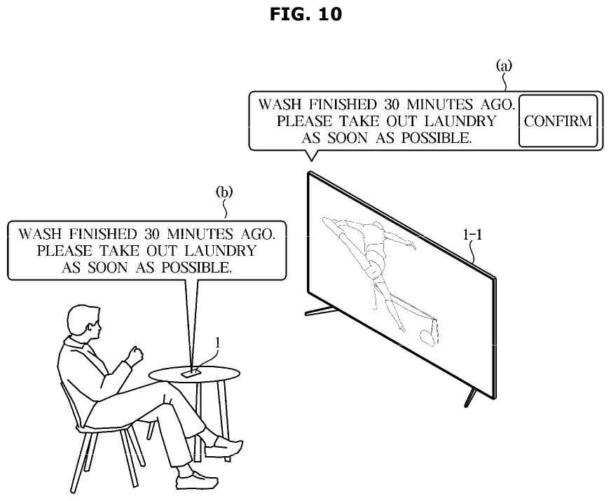

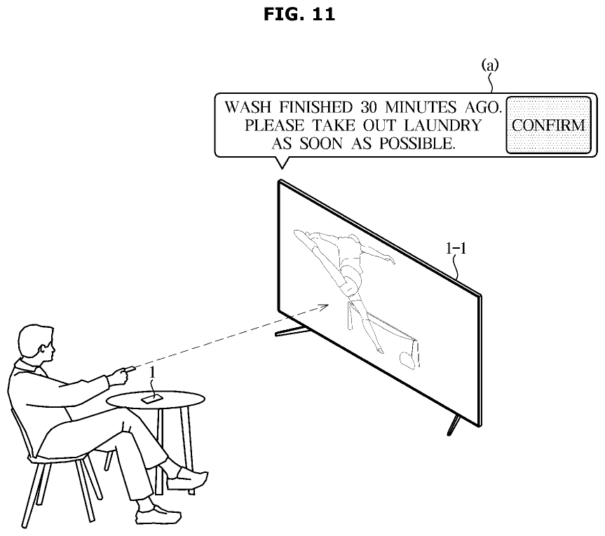

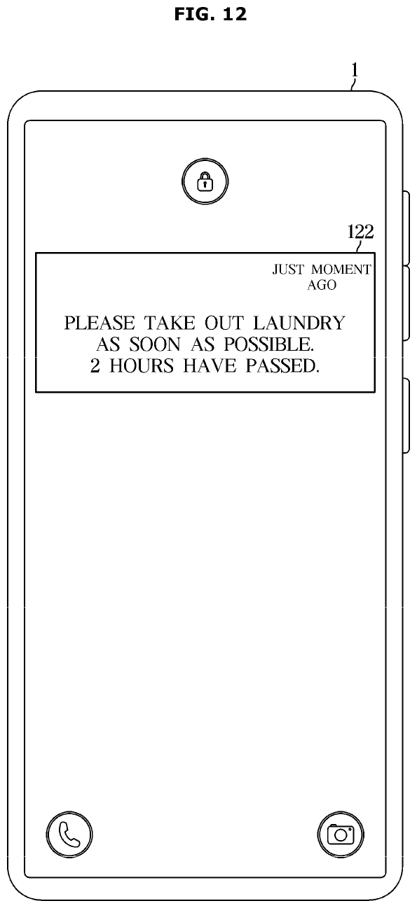

FIG. 10 is a diagram illustrating that a notification message corresponding to an event occurrence is received in a plurality of electronic devices according to an embodiment. FIG. 11 is a diagram illustrating that a notification message is confirmed in any one of the plurality of electronic devices according to an embodiment. FIG. 12 is a diagram illustrating that a notification message is reconstructed and displayed in another of the plurality of electronic devices according to an embodiment.

Referring to FIG. 10, a washing machine, which is an external electronic device, may transmit an event occurrence signal to the server device 2 in response to an occurrence of an event of a reserved wash notification. In response to the above, the server device 2 may transmit a notification message and keyword metadata corresponding to the occurrence of the event to a smartphone 1 and a smart TV 1-1 which are the electronic device 1.

The controller 100 of each of the electronic devices 1 may receive the notification message and the keyword metadata from the server device 2, and display the notification message of “Wash finished 30 minutes ago. Please take the laundry out quickly.” (a, b) on the outputter 122 of each of the electronic devices 1.

Referring to FIG. 11, a user may input a notification acknowledgement action for acknowledging the notification message through a remote control. That is, the user may acknowledge the notification message (a) received in the smart TV 1-1 by operating the remote control of the smart TV 1-1. Specifically, the user may acknowledge the notification message (a) by clicking “confirm” which is a graphic interface displayed together with the notification message (a).

Referring to FIG. 12, based on a notification acknowledgement action being input to the other electronic device 1 receiving the same notification message, the controller 100 may differently determine at least one keyword of the electronic device 1.

Specifically, because the same notification message has been received in the smartphone 1 and the smart TV 1-1 in FIG. 10 and the notification acknowledgement action has been input by the user to the smart TV 1-1 in FIG. 11, the controller 100 of the smartphone 1 of FIG. 12 may reconstruct the notification message.

Based on a determination that the user has input the notification acknowledgement action to the smart TV 1-1, which is the other electronic device 1, the controller 100 may determine whether the user's contextual information has changed at a time that the notification acknowledgement action is input.

Specifically, the controller 100 may determine whether one hour, which is a preset reference time, has elapsed from a time that the notification message is received to a time that the notification acknowledgement action is input. In FIG. 12, because a period of time from the time that the notification message is received to the time that the notification acknowledgement action is input is 2 hours, the controller 100 may determine that the user's contextual information has changed.

Accordingly, the controller 100 may select keywords corresponding to the changed contextual information, “possible” and “2 hours”, in the memory 102. Thereafter, the controller 100 may update the keywords to reconstruct the notification message from “Wash finished 30 minutes ago. Please take the laundry out quickly” to “Please take the laundry out as soon as possible. It has been 2 hours”.

That is, in a case where the user acknowledges the notification message in the other electronic device 1, the user may be aware of an action requested by the notification message, and thus the controller 100 may reconstruct the notification message to urge the action requested by the notification message.

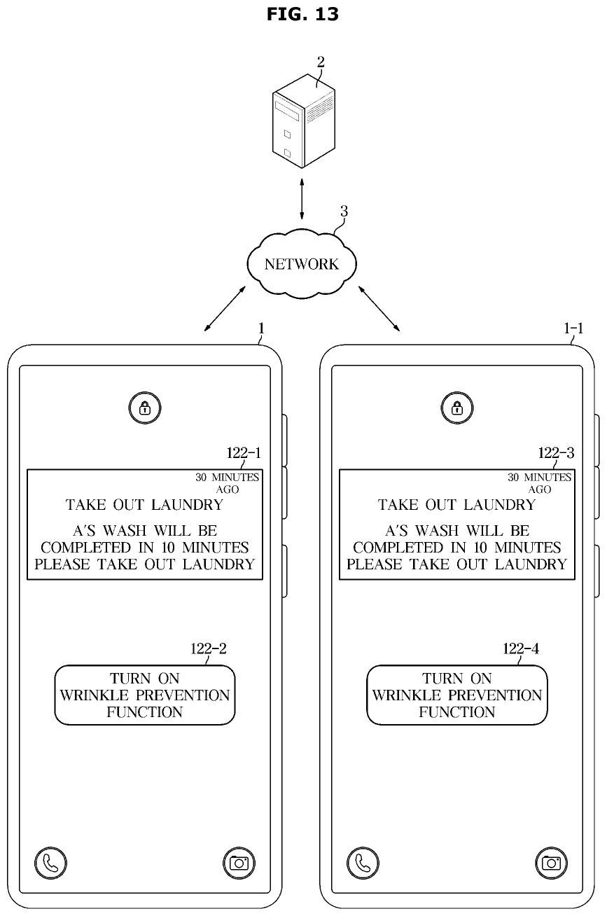

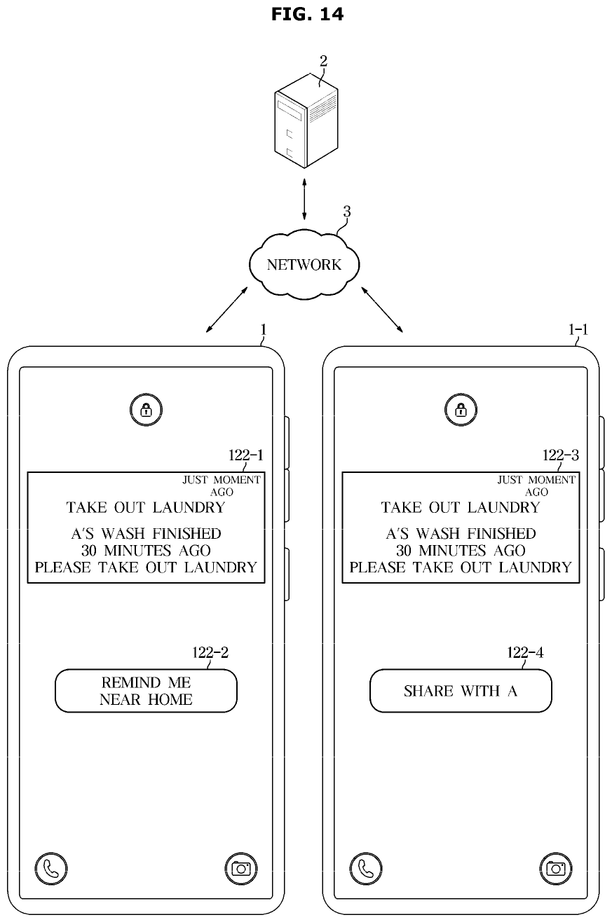

FIG. 13 is a diagram illustrating that a notification message corresponding to an event occurrence is received in a plurality of electronic devices according to an embodiment. FIG. 14 is a diagram illustrating notification messages reconstructed and displayed differently in the plurality of electronic devices according to an embodiment.

Referring to FIG. 13, a washing machine, which is an external electronic device, may transmit an event occurrence signal to the server device 2 through the network 3 in response to an occurrence of an event of a wash end notification. In response to the event occurrence signal, the server device 2 may transmit a notification message and keyword metadata corresponding to the event occurrence to a plurality of smartphones 1 and 1-1 which are the electronic device 1. In this instance, the plurality of smartphones 1 and 1-1 have different users, a user A and a use B, respectively.

The controller 100 of each of the smartphones 1 and 1-1 may receive the notification message and the keyword metadata from the server device 2, and may display, on the outputter 122 (122-1, 122-2, 122-3 and 122-4) of each of the smartphones 1 and 1-1, the notification messages of “Take the laundry out”, “A's wash will be completed in 10 minutes. Please take the laundry out” and “Turn on the wrinkle prevention function”, together with “30 minutes ago” which is an elapsed time since the notification message was received.

Referring to FIG. 14, the controller 100 of each of the smartphones 1 and 1-1 may reconstruct the notification message, based on a notification acknowledgement action being input from a user.

For the user A's smartphone 1, based on a notification acknowledgement action being input from the user, the controller 100 may determine whether the user's contextual information has changed at a time that the notification acknowledgement action is input. Specifically, the controller 100 may determine that the user's contextual information has changed, based on an event from a time that the notification message was received being different from an event from the time that the notification acknowledgement action is input, or based on a location of the user from the time that the notification message was received being different from a location of the user from the time that the notification acknowledgement action is input.

In FIG. 14, because the event at the time that the notification message was received in the user A's smartphone 1 is that the wash is about to end and the event at the time that the notification acknowledgement action is input is that the wash is finished, it may be determined that the contextual information has changed. Also, because the user A is located outside the house and is logged in with the same ID as the washing machine-associated account, the controller 100 may determine that the contextual information has changed based on the user's location.

Accordingly, the controller 100 may select keywords corresponding to the changed contextual information, “30 minutes ago”, “near home” and “remind”, in the memory 102. The controller 100 may then update the keywords on the upper outputter 122-1 to reconstruct the notification message from “A's wash will be completed in 10 minutes” to “A's wash finished 30 minutes ago”. Also, the controller 100 may update the keywords on the lower outputter 122-2 to reconstruct the notification message from “Turn on the wrinkle prevention function” to “Remind me near home”.

For the user B's smartphone 1-1, the notification message on the upper outputter 122-3 may be changed to “A's wash finished 30 minutes ago” like for the user A.

On the other hand, in a case of the lower outputter 122-4, because the washing machine is logged in with the user A's account and the smartphone 1-1 is logged in with the user B's account, the account information is different from each other, and thus the keywords may be updated differently based on the different account information.

That is, because the user B is able to use the washing machine only after the user A takes the laundry out of the washing machine, a notification message such as “Share with the user A” may be output to the user B on the lower outputter 122-4. As described above, by displaying a notification message appropriate for a situation and a user, user satisfaction and notification efficiency may be maximized.

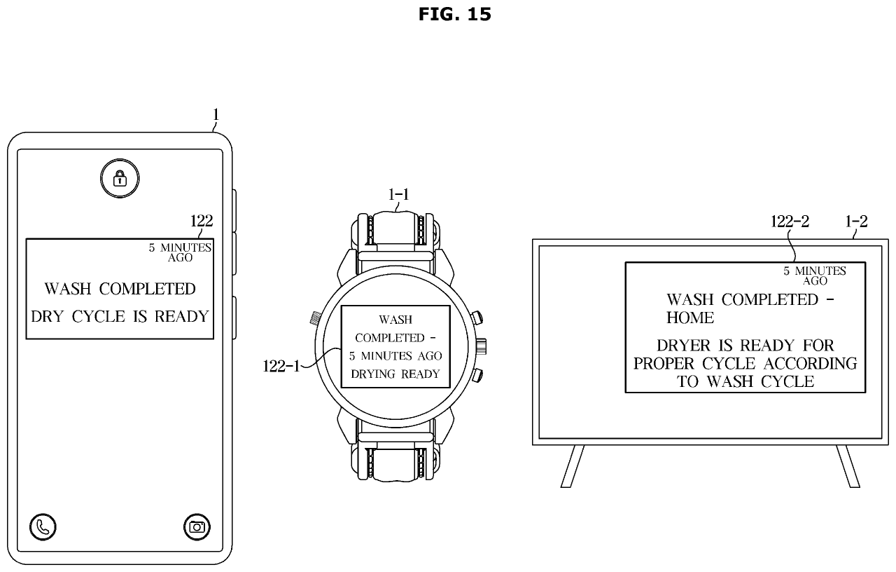

FIG. 15 is a diagram illustrating notification messages reconstructed and displayed differently in a plurality of electronic devices according to an embodiment.

Referring to FIG. 15, a washing machine, which is an external electronic device, may transmit an event occurrence signal to the server device 2 via the network 3 in response to an occurrence of an event of a wash end notification. In response to the above, the server device 2 may transmit a notification message and keyword metadata corresponding to the event occurrence to a smartphone 1, a smartwatch 1-1, a smart TV 1-2, and a terminal monitor 1-2, which are the plurality of electronic devices 1. In these descriptions, multiple electronic devices 1 may be referred to as 1, 1-1, 1-2, 1-3, and so on.

The controller 100 of each of the electronic devices 1 may receive the notification message and the keyword metadata from the server device 2, and display, on the outputter 122-1, 122-2 and 122-3 of each of the electronic devices 1, the notification message of “Proper dry cycle is ready” together with “5 minutes ago” which is an elapsed time since the notification message was received.

The controller 100 of each of the electronic devices 1 may then determine whether contextual information of the user has changed, and the user's contextual information may include information about a size of a display of the electronic device 1 used by the user or information about a displayed text size.

The controller 100 of each of the electronic devices 1 may determine the number of keywords based on the information about the size of the display on which the notification message is to be displayed, and may reduce the number of keywords as the display size is larger. Similarly, the controller 100 may reduce the number of keywords as the size of text displayed on the display is larger. Also, in a case where the notification message is audibly output, the number of keywords may be determined based on a time required for the notification message to be audibly output.

For example, because the display of the smartphone 1 of FIG. 15 lacks space for displaying the keyword of “proper” among the three keywords of “proper”, “dry cycle” and “is ready”, the controller 100 may omit “proper” and display only two keywords, “dry cycle” and “is ready”, based on the priorities to be described later.

In another example, because the display size of the smartwatch 1-1 of FIG. 15 is smaller than that of the smartphone 1, the display of the smartwatch 1-1 lacks space for displaying the keyword of “proper” among the three keywords of “proper”, “dry cycle” and “is ready”, the controller 100 may omit “proper” and display only two keywords, “dry cycle” and “is ready”, based on the priorities to be described later, and also omit messages other than the keywords.

In still another example, because the display size of the smart TV 1-2 of FIG. 15 is sufficient to display all the keywords, all of the three keywords of “proper”, “dry cycle” and “is ready” may be selected and the notification message may be maintained as “Proper dry cycle is ready”.

As described above, the controller 100 of the electronic device 1 may determine priorities of keywords, and determine keywords to be omitted upon reducing the number of keywords.

The priorities of keywords may be stored in the memory 102 in advance, and in a case of a plurality of keywords having the same priority, a keyword displayed at a later part may be omitted from the notification message.

For example, because “dry cycle” and “is ready” refer to an operation and a state of the electronic device 1, and “proper” corresponds to a modifier, “dry cycle” and “is ready” may have higher priorities than a priority of “proper”.

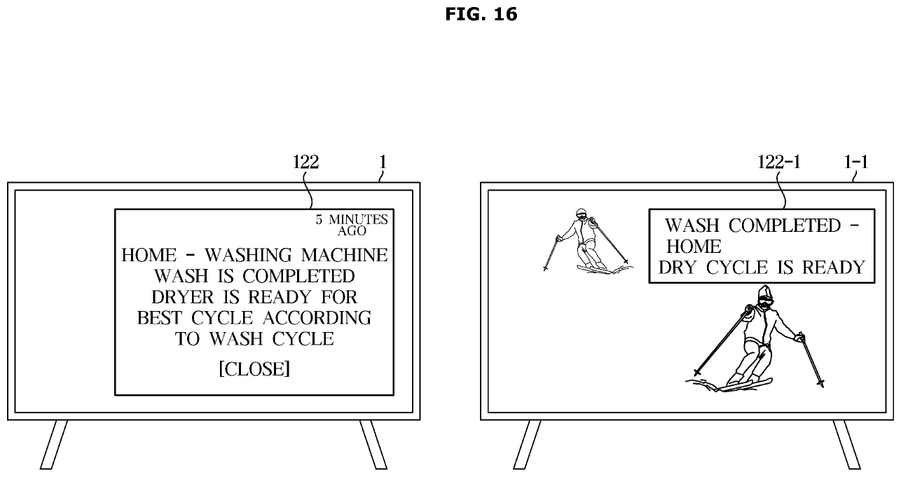

FIG. 16 is a diagram illustrating that notification messages are differently reconstructed and displayed based on whether content is being displayed in an electronic device according to an embodiment.

Referring to FIG. 16, a washing machine, which is an external electronic device, may transmit an event occurrence signal to the server device 2 via the network 3 in response to an occurrence of an event of a wash end notification. In response to the above, the server device 2 may transmit a notification message and keyword metadata corresponding to the event occurrence to smart TVs 1 and 1-1 which are the electronic devices 1.

The controller 100 of each of the electronic devices 1 may receive the notification message and the keyword metadata from the server device 2, and display, on the outputter 122, the notification message of “home—washing machine. Wash is completed. Dryer is ready for the best cycle according to wash cycle”, together with “5 minutes ago” which is an elapsed time since the notification message was received.

The controller 100 of each of the electronic devices 1 may determine whether contextual information of the user has changed, and the user's contextual information may include information about whether image content is being displayed on the outputter 122 of the electronic device 1.

The controller 100 of each of the electronic devices 1 may reduce the number of keywords, in response to the image content being displayed on the outputter 122 of the electronic device 1. In addition, in a case where the notification message is audibly output and audio content is being output on the outputter 122, the number of keywords may be reduced.

For example, because image content is not being displayed on the outputter 122 of the smart TV 1 on the left in FIG. 16, the notification message received from the server device 2 may be maintained. On the other hand, because image content is being displayed on the outputter 122-1 of the smart TV 1-1 on the right, the number of keywords may be reduced in order not to interfere with a user's view of the image content.

That is, based on priorities of eight keywords, “home”, “washing machine”, “wash”, “completed”, “wash cycle”, “dryer”, “best cycle”, and “is ready”, the controller 100 may omit the “washing machine”, “wash cycle”, and “best cycle”, and rearrange and display only the five keywords “wash”, “completed”, “home”, “dryer” and “is ready”.

Thus, according to the notification message display method according to an embodiment, the notification message may be effectively delivered to the user without causing inconvenience to the user in using the electronic device 1.

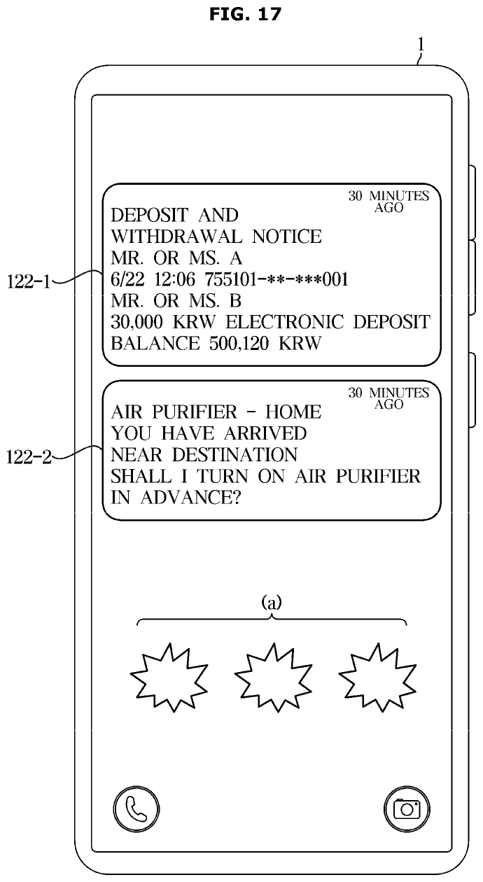

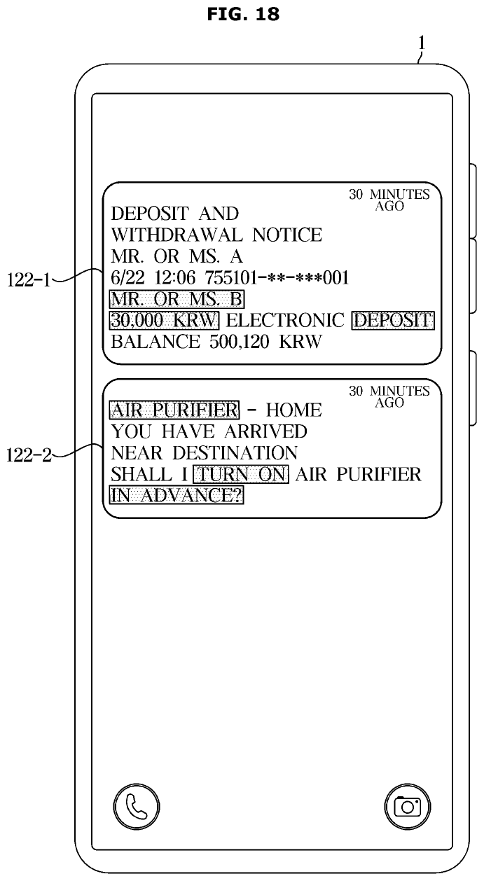

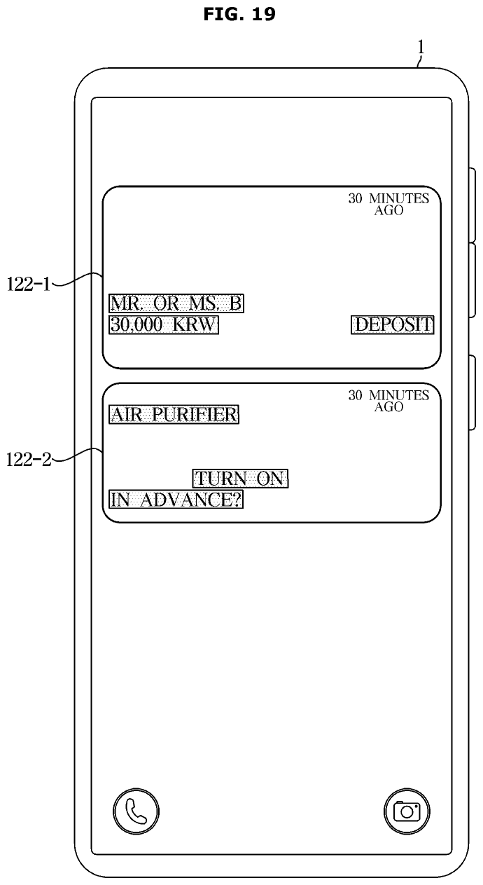

FIG. 17 is a diagram illustrating preset interactions which are input by a user to an electronic device according to an embodiment. FIG. 18 is a diagram illustrating keywords highlighted based on user interaction in an electronic device according to an embodiment. FIG. 19 is a diagram illustrating that only keywords are displayed by omitting messages other than the keywords based on user interaction in an electronic device according to an embodiment.

Referring to FIG. 17, based on an input of a user command which is a preset interaction (a) to the inputter 121, a notification message may be reconstructed by highlighting or omitting at least one keyword.

A dryer, which is an external electronic device, may transmit an event occurrence signal to the server device 2 via the network 3 in response to an occurrence of an event of a wash end notification. In response to the above, the server device 2 may transmit a notification message and keyword metadata corresponding to the event occurrence to the smartphone 1 which is the electronic device 1.

In addition, based on an event occurrence signal related to a deposit generated by the server device 2 itself, the server device 2 may transmit a notification message and keyword metadata corresponding to the event occurrence to the smartphone 1.

The controller 100 of the electronic device 1 may receive the notification message and the keyword metadata from the server device 2, and display, on the outputters 122-1 and 122-2, the notification messages of “Deposit and withdrawal notice: Mr. or Ms. A, 22 June, 12:06 pm, 755101-**-*** 001, Mr. or Ms. B, 30,000 KRW Electronic deposit, Balance of 500,120 KRW” and “Air purifier—Home. You have arrived near your destination. Shall I turn on the air purifier in advance?”, respectively, together with “30 minutes ago” which is an elapsed time since the notification message was received.

Based on the user input of the preset interaction (a) to the inputter 121, the controller 100 may reconstruct the notification message by highlighting a keyword or omitting a message other than the keyword. In this instance, the interaction (a) refers to, for example, a preset action of double-tapping a display of the smartphone with the user's three fingers.

Referring to FIG. 18, the controller 100 may reconstruct the notification message by highlighting the keyword, based on the user input of the preset interaction (a) to the inputter 121. As shown in FIG. 18, “Mr. or Ms. B”, “30,000 KRW”, and “deposit” may be highlighted in bold text or background fill on the upper outputter 122-1. Similarly, on the lower output 122-2, “air purifier” and “turn on in advance” may be highlighted in bold text or background fill.

Referring to FIG. 19, the controller 100 may reconstruct the notification message by omitting the rest of the message except for the keyword, based on the user input of the preset interaction (a) to the inputter 121.

As shown in FIG. 19, only “Mr. or Ms. B”, “30,000 KRW”, and “deposit” may be displayed by omitting the rest of the message on the upper outputter 122-1. Similarly, on the lower output 122-2, “air purifier” and “turn on in advance” may be highlighted by omitting the rest of the message.

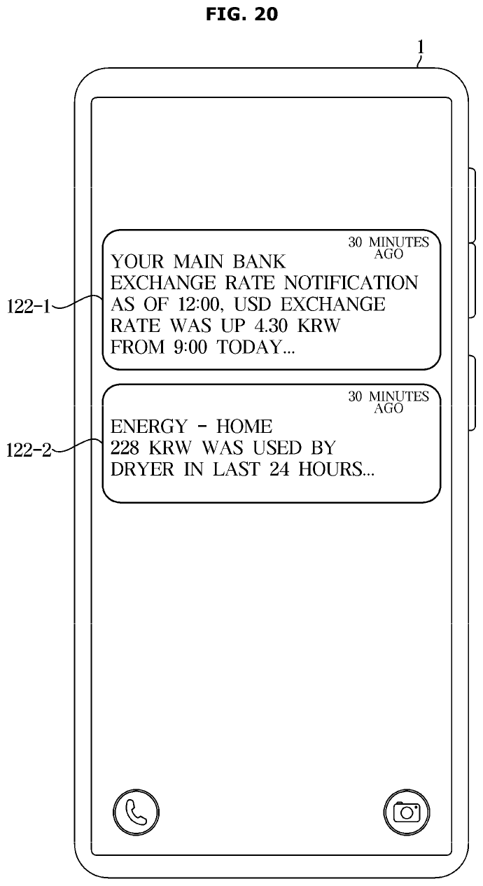

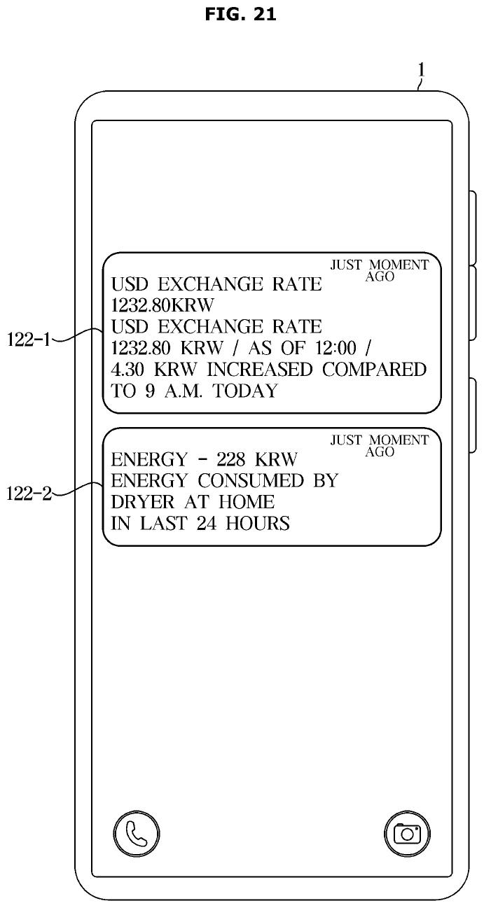

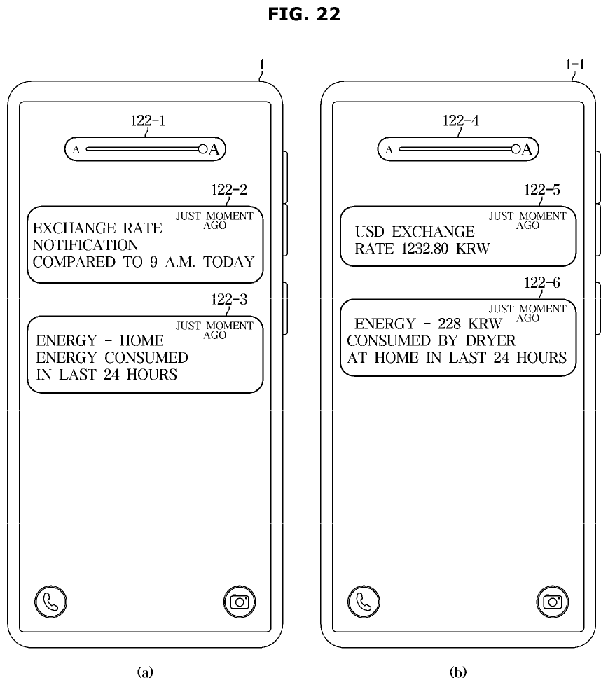

FIG. 20 is a diagram illustrating that notification messages corresponding to event occurrence are received in an electronic device according to an embodiment. FIG. 21 is a diagram illustrating that notification messages are reconstructed based on keywords in an electronic device according to an embodiment. FIG. 22 is a diagram illustrating a difference in information depending on whether a notification message is reconstructed, in response to increasing a text size in an electronic device according to an embodiment.

Referring to FIG. 20, a dryer, which is an external electronic device, may transmit an event occurrence signal to the server device 2 via the network 3 in response to an occurrence of an event of an energy use notification. In response to the above, the server device 2 may transmit a notification message and keyword metadata corresponding to the event occurrence to the smartphone 1 which is the electronic device 1.

In addition, based on an event occurrence signal related to an exchange rate notification generated by the server device 2 itself, the server device 2 may transmit a notification message and keyword metadata corresponding to the event occurrence to the smartphone 1 which is the electronic device 1.

The controller 100 of the electronic device 1 may receive the notification message and the keyword metadata from the server device 2, and display, on the outputters 122-1 and 122-2, the notification messages of “Your main bank exchange rate notification—As of 12:00, the USD exchange rate was up 4.30 KRW from 9:00 today . . . ” and “Energy—Home. 228 KRW was used by the dryer in the last 24 hours . . . ”, respectively, together with “30 minutes ago” which is an elapsed time since the notification message was received.

Referring to FIG. 21, the controller 100 may display keywords first, and display the rest of the message other than the keywords later. In addition, the controller 100 may display a higher priority keyword before a lower priority keyword based on priorities of the keywords stored in the memory 102.

Accordingly, based on a notification acknowledgement action being input from a user, the controller 100 may reconstruct and display the notification message on the upper output unit 122-1 as “USD exchange rate 1232.80 KRW as of 12:00, 4.30 KRW increased with regard to 9 a.m. today”. The controller 100 may reconstruct the notification message by arranging the keywords, “USD exchange rate”, “1232.80 KRW”, “as of 12:00”, “with regard to 9 a.m. today”, “4.30 KRW”, and “increased” on the upper outputter 122-1 of FIG. 20, and omitting the rest of the message.

The controller 100 may reconstruct and display the notification message on the lower output 122-2 as “Energy—228 KRW. Energy consumed by the dryer at home in the last 24 hours”. Similarly, the controller 100 may reconstruct the notification message by arranging the keywords, “energy”, “228 KRW”, “home”, “dryer”, and “last 24 hours”, and omitting the rest of the message.

An effect thereof is described with reference to FIG. 22.

Referring to FIG. 22, the upper outputter 122-1 of the smartphone 1 on the left shows maximizing a text size in a state where the notification message display method of the electronic device according to an embodiment is not applied, and the upper outputter 122-4 of the smartphone 1-1 on the right shows maximizing a text size in a state where the notification message display method of the electronic device according to an embodiment is applied.

For the smartphone 1 on the left, because the notification message display method of the electronic device according to an embodiment is not applied, the notification message is not reconstructed. Accordingly, in response to the text size being maximized, only “Bank exchange rate notification with regard to 9 a.m. today” may be displayed on the middle outputter 122-2, and only “Energy—the energy consumed in the last 24 hours” may be displayed on the lower outputter 122-3. Conventionally, exchange rate information and energy information, which are the information desired by the user, may be omitted.

According to the notification message display method of the electronic device according to an embodiment, even when the text size is maximized like in the smartphone 1-1 on the right, “USD exchange rate 1232.80 KRW” may be displayed on the middle outputter 122-5, and “228 KRW—Energy consumed by the dryer at home in the last 24 hours” may be displayed on the lower outputter 122-6.

Thus, according to the notification message display method of the electronic device according to an embodiment, the exchange rate information and energy information, which are the information desired by the user, may be delivered to the user without omission, and even when the information is output audibly, a user may be quickly provided with the desired information by listening only to the first few parts.

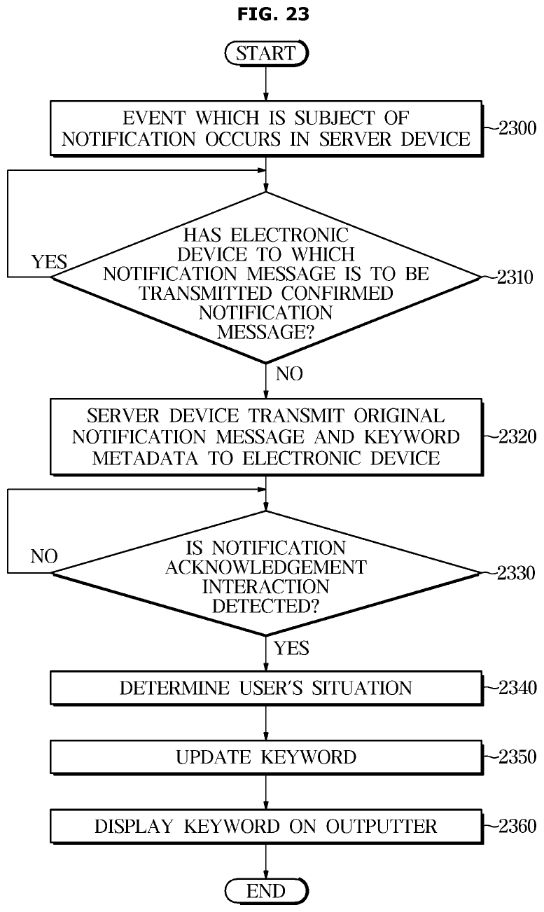

FIG. 23 is a flowchart illustrating operations of an electronic device according to an embodiment.

Referring to FIG. 23, an event, which is a subject of notification, occurs in the server device 2 (2300). In this instance, an event occurrence signal such as an end of wash may be generated from an external electronic device 1, or an event occurrence signal such as a deposit notification may be generated from the server device itself.

The server device 2 may determine whether the electronic device 1 to which a notification message is to be transmitted has confirmed the notification message (2310). In a case where the electronic device 1 has confirmed the notification message (Yes in operation 2310), the server device 2 is not required to transmit the notification message to the electronic device 1, and thus the server device 2 may exclude the electronic device 1 from a transmission target. In a case where the electronic device 1 has not confirmed the notification message (No in operation 2310), the server device 2 may transmit the original notification message and keyword metadata to the electronic device 1 (2320).

The controller 100 of the electronic device 1 may determine whether a notification acknowledgement interaction from a user is detected in the inputter 121 (2330). Based on a determination that a user's notification acknowledgement action has been input to the inputter 121 (Yes in operation 2330), the controller 100 of the electronic device 1 may determine contextual information of the user (2340). Specifically, the controller 100 may determine whether the user's contextual information has changed, and update a keyword based on the user's changed contextual information (2350).

The controller 100 of the electronic device 1 may display a notification message including the updated keyword on the outputter 122 (2360).

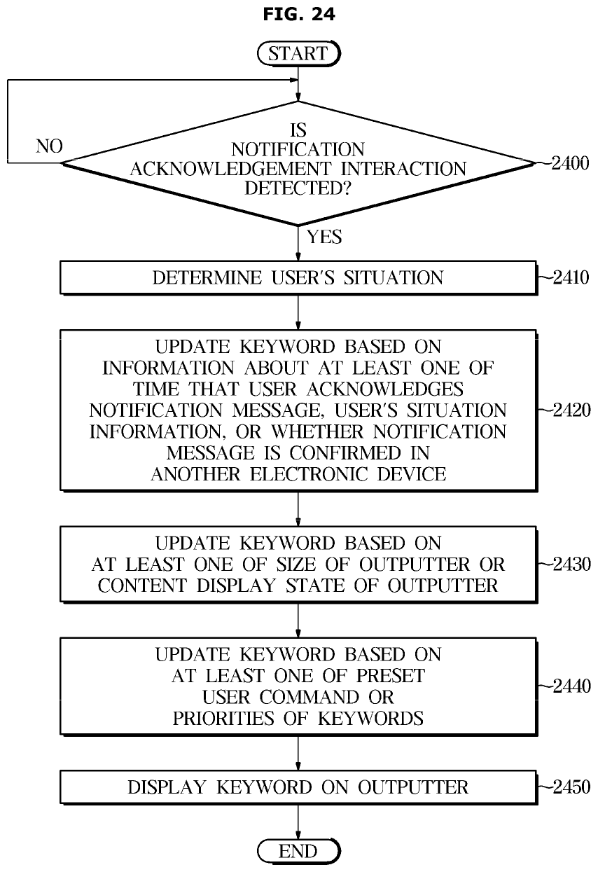

FIG. 24 is a flowchart specifically illustrating operations of updating a keyword in an electronic device according to an embodiment.

Referring to FIG. 24, the controller 100 of the electronic device 1 may determine whether a notification acknowledgement interaction from a user is detected in the inputter 121 (2400). Based on a determination that a user's notification acknowledgement action has been input to the inputter 121 (Yes in operation 2400), the controller 100 of the electronic device 1 may determine user's contextual information (2410).

As described above, the controller 100 of the electronic device 1 may update a keyword based on information about at least one of a time that a user acknowledges a notification message, a user's situation information, or whether the notification message is confirmed in another electronic device 1 (2420). In addition, the controller 100 may update the keyword based on at least one of a size of the outputter 122 or a content display state of the outputter 122 (2430). The controller 100 may also update the keyword based on at least one of a preset user command or priorities of keywords (2440).

However, the operation 2420 to the operation 2440 may be performed in parallel, without being limited to the above order.

The controller 100 of the electronic device 1 may display a notification message including the updated keyword on the outputter 122 (2450).

As described above, according to the notification message display method of the electronic device according to an embodiment, randomly consumed notification messages may be effectively delivered and a notification message appropriate to a user's situation may be displayed. Thus, user convenience and satisfaction may be maximized.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Also, the computer-readable recording medium may be provided in the form of a non-transitory storage medium, wherein the term ‘non-transitory storage medium’ simply means that the storage medium is a tangible device, and does not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store (e.g., Play Store™) or between two user devices (e.g., smartphones) directly. When distributed online, at least part of the computer program product (e.g., a downloadable app) may be temporarily generated or at least temporarily stored in the machine-readable storage medium, such as a memory of the manufacturer's server, a server of the application store, or a relay server.

While the disclosure has been particularly described with reference to exemplary embodiments, it should be understood by those skilled in the art that various changes in form and detail may be made without departing from the spirit and scope of the disclosure.

1. A notification message display method of an electronic device, the method comprising:
receiving, from a server device, a notification message and keyword metadata corresponding to an event occurrence of an external electronic device;
determining contextual information of a user based on a notification acknowledgement action being input from the user;
determining at least one keyword that corresponds to the determined contextual information; and
based on the determined at least one keyword and the determined contextual information:
maintaining the notification message and displaying the maintained notification message on a screen, or
reconstructing the notification message and displaying the reconstructed notification message on the screen.

2. The notification message display method of claim 1, wherein
the determining of the at least one keyword includes:
determining whether the contextual information of the user is changed, and
based on determining that the contextual information is changed, determining the at least one keyword that corresponds to the changed contextual information.

3. The notification message display method of claim 2, wherein
the determining of whether the contextual information of the user is changed includes determining that the contextual information of the user is changed based on an event at a time that the notification message was received being different from an event at a time that the notification acknowledgement action is input.

4. The notification message display method of claim 2, wherein
the determining of whether the contextual information of the user is changed includes determining that the contextual information of the user is changed based on a location of the user at a time that the notification message was received being different from a location of the user at a time that the notification acknowledgement action is input.

5. The notification message display method of claim 1, wherein
the determining of the at least one keyword includes reducing a quantity of the at least one keyword based on a size of the screen.

6. The notification message display method of claim 5, wherein
the reducing of the quantity of the at least one keyword includes reducing the quantity of the at least one keyword by omitting a low priority keyword.

7. The notification message display method of claim 1, wherein
the determining of the at least one keyword includes reducing a quantity of the at least one keyword based on content being displayed on the screen.

8. The notification message display method of claim 1, wherein
the determining of the at least one keyword includes reducing a quantity of the at least one keyword due to a size of a text displayed on the screen.

9. The notification message display method of claim 1, wherein
the determining of the at least one keyword includes differently determining the at least one keyword of the electronic device, based on the notification acknowledgement action being input to the external electronic device.

10. The notification message display method of claim 1, wherein
the reconstructing of the notification message includes, based on a preset user command being input to an inputter:
reconstructing the notification message by highlighting the at least one keyword, or
omitting the notification message except for the at least one keyword.

11. An electronic device, comprising:
a communicator configured to receive, from a servicer device, a notification message and keyword metadata corresponding to an event occurrence of an external electronic device;
an inputter configured to receive a user command from a user;
a screen; and
a controller configured to:
determine contextual information of the user based on a notification acknowledgement action being input from the user,
determine at least one keyword that that corresponds to the determined contextual information, and
based on the determined at least one keyword and the determined contextual information:
maintain the notification message and control the screen to display the maintained notification message, or
reconstruct the notification message and control the screen to display the reconstructed notification message.

12. The electronic device of claim 11, wherein
the controller is configured to:
determine whether the contextual information of the user is changed, and
based on determining that the contextual information is changed, determine the at least one keyword that corresponds to the changed contextual information.

13. The electronic device of claim 12, wherein
the controller is configured to determine that the contextual information of the user is changed based on an event at a time that the notification message was received being different from an event at a time that the notification acknowledgement action is input.

14. The electronic device of claim 12, wherein
the controller is configured to determine that the contextual information of the user is changed based on a location of the user at a time that the notification message was received being different from a location of the user at a time that the notification acknowledgement action is input.

15. The electronic device of claim 11, wherein
the controller is configured to reduce a quantity of the at least one keyword based on a size of the screen.
